(19) United States
(12) Patent Application Publication
(10) Pub. No.: US 2006/0289072 A1
(43) Pub. Date: Dec. 28, 2006

(54) Wastegate valve and associated method

(76) Inventors: Robert McMullen, Commerce Twp, MI (US); Mark E. Groskreutz, Long Beach, CA (US)

Correspondence Address: HONEYWELL TURBO TECHNOLOGIES, 23326 HAWTHORNE BOULEVARD, SUITE #200, TORRANCE, CA, 90505, US

(21) Appl. No.: 11/168,804

(22) Filed: Jun. 28, 2005

(51) Int. Cl. F16K 31/44

(52) U.S. Cl. 137/601.01

(57) ABSTRACT

A wastegate valve and associated method for controlling a flow of gas, such as a flow of exhaust gas from an exhaust inlet of a turbocharger, are provided. The wastegate valve includes multiple bypass ports that are selectively opened and closed by poppets, which are controlled by a linkage. The poppets are configured so that the pressure of the gas in the exhaust inlet biases one of the poppets to the open position and one of the poppets to the closed position. Thus, the forces resulting from the pressure of the gas on the poppets are offset, thereby reducing the force required for adjusting or maintaining the position of the linkage and the poppets.

### FIELD OF THE INVENTION

The present invention relates generally to a wastegate valve, such as can be used for controlling the flow of gas from an exhaust inlet of a turbocharger, and more particularly relates to a wastegate valve and associated method in which the pressure of the gas in the exhaust inlet is substantially balanced on the valve.

### BACKGROUND OF THE INVENTION

Turbocharger are generally used to extract energy from the exhaust gas of an internal combustion engine and compress air that is then delivered to the intake of the engine for combustion. A typical turbocharger includes a compressor and a turbine with rotatable wheels that are connected by a shaft. The compressor is configured to receive air, compress the air, and provide the air to the engine for combustion. The turbine is configured to receive a flow of exhaust gas from the engine, such that the exhaust gas rotates the wheel of the turbine and thereby operates the compressor.

The maximum operating pressure of the compressor and the turbine can be limited by operating a wastegate valve that controls the flow of exhaust gas from the exhaust inlet of the turbine. The wastegate valve is normally provided in a closed position so that the exhaust gas provided to the turbine is directed toward the turbine wheel and operates to rotate the wheel and, hence, the compressor. The wastegate valve can be opened, e.g., if the exhaust gas exceeds a predetermined pressure, thereby preventing the compressor from being operated outside a desired range. In the open position, the wastegate valve discharges or vents at least a portion of the exhaust gas from the exhaust inlet to bypass the turbine wheel.

The wastegate valve includes one or more valve members, such as poppets, that control the flow of exhaust gas from the exhaust inlet. For example, the exhaust inlet can define one or more paths for the exhaust gas, and the poppets can be configured to control the flow of the gas out of the exhaust inlet. If two poppets are used, such as for separately controlling two separate flows of exhaust gas from the inlet, the poppets can be mechanically connected to each other so that both poppets are opened and closed in unison. Thus, a single actuator can be coupled to the poppets and used to selectively open and close the wastegate valve. That is, if the poppets are biased toward an open position by the pressure of the gas in the exhaust inlet, the actuator can be configured to hold the poppets closed during normal operation and release the poppets to open when bypassing of the exhaust gas is desired.

The force and/or energy required for controlling the wastegate valve can be substantial. For example, as the sizes of the poppets are increased to accommodate greater flows of exhaust gas, the force of the exhaust gas on the poppets generally increases. The increase in the force required for controlling the poppets can require the use of an actuator that is larger, more powerful, and more expensive. In some cases, the size of the required actuator complicates or prevents the effective packaging of the actuator on the engine.

Thus, there exists a need for an improved wastegate valve and an associated method. The wastegate valve should be capable of controlling the flow of gas from an exhaust inlet of a turbocharger. Further, the valve should reduce the force required for controlling the flow.

### BRIEF SUMMARY OF THE INVENTION

According to one embodiment, the present invention provides a wastegate valve for controlling a flow of gas from an exhaust inlet of a turbocharger. The wastegate valve includes first and second bypass ports in communication with the exhaust inlet, and first and second adjustable members, such as poppets, that adjust to open or close the respective bypass ports. The first poppet is configured so that the gas in the exhaust inlet tends to adjust the poppet to the open position and/or maintain the first poppet in the open position. The second poppet is configured so that the gas in the exhaust inlet tends to adjust the poppet to the closed position and/or maintain the second poppet in the closed position. That is, the first and second poppets are biased to opposite open and closed positions by the gas in the exhaust inlet. Further, the poppets are connected by a linkage, such as a mechanical linkage of link members or gears, which is configured to adjust alternately to open and close the poppets. Thus, a gas in the exhaust inlet provides forces on the first and second poppets that bias the linkage in opposite directions, such that the forces on the poppets at least partially offset each other. In particular, the linkage can include first and second cranks that are connected to the poppets, respectively, and a link member that connects the cranks to constrain the poppets to adjust in unison. Alternatively, the linkage can include first and second gears that are connected to the poppets, respectively, and a third gear that communicates with the other gears to constrain the poppets to adjust in unison.

The present invention also provides an associated method for controlling a flow of gas from an exhaust inlet. According to one aspect of the invention, first and second adjustable poppets are provided, each being adjustable between open and closed positions for opening and closing respective bypass ports. A linkage connected to the first and second poppets is selectively adjusted in a first direction to open the poppets and in a second direction to close the poppets. A pressure on the first poppet provided by the gas in the exhaust inlet biases the linkage in the first direction, and a pressure on the second poppet provided by the gas in the exhaust inlet biases the linkage in the second direction, such that the two forces on the poppets oppose on another to at least partially balance the linkage.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is an elevation view, partially in section, illustrating a turbocharger with a schematic representation of a wastegate valve according to one embodiment of the present invention;

FIG. 2 is perspective view illustrating the wastegate valve according to one embodiment of the present invention;

FIG. 3 is an elevation view illustrating the wastegate valve of FIG. 2 with the housing cover removed; and

FIG. 4 is an elevation view corresponding to FIG. 3, illustrating the poppets in open positions;

FIG. 5 is a section view illustrating the wastegate valve of FIG. 3, as seen along line 5-5;

FIG. 6 is an elevation view illustrating a wastegate valve according to another embodiment of the present invention, shown with the housing cover removed; and

FIG. 7 is an section view illustrating the wastegate valve of FIG. 6, as seen along line 7-7.

### DETAILED DESCRIPTION OF THE INVENTION

The present inventions now will be described more fully hereinafter with reference to the accompanying drawings, in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

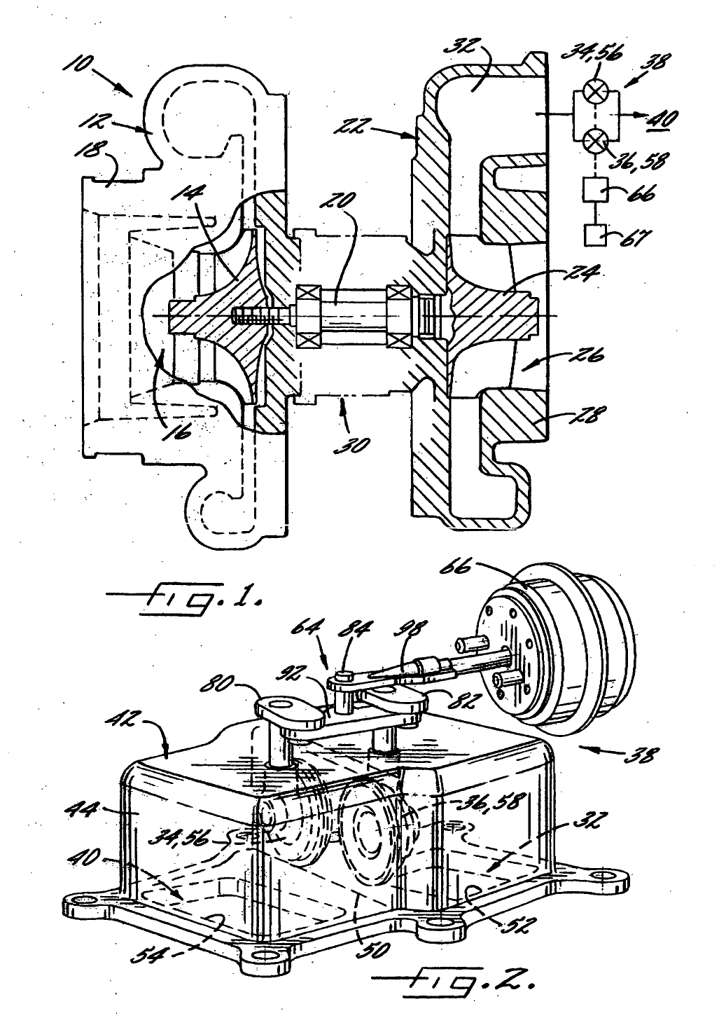

Referring now to the figures and, in particular, to FIG. 1, there is shown a turbocharger 10 that can be used for increasing the pressure of the intake air delivered to an internal combustion engine. The turbocharger 10 includes a compressor 12 with a compressor wheel 14 that is rotatably mounted in a cavity or aperture 16 defined by a compressor housing 18. A shaft 20 connects the compressor wheel 14 to a turbine 22 and, in particular, to a turbine wheel 24 that is rotatably mounted in a cavity 26 of a turbine housing 28. The shaft 20 is rotatably mounted in a center housing 30 disposed between the compressor 12 and the turbine 22. In operation, the turbine wheel 24 can be rotated by a flow of the exhaust gas through the turbine housing 28, thereby rotating the shaft 20 so that the compressor wheel 14 compresses air flowing through the compressor housing 18 and delivers the compressed air to the intake of the engine. While one embodiment of a turbocharger 10 is illustrated in FIG. 1, it is appreciated that other configurations of turbochargers can be used in accordance with the present invention. Further, in other embodiments of the present invention, the turbine 22 can be operated by different gases and/or the compressor 12 can be used to compress other gases, which can be used for other purposes and in conjunction with devices other than turbochargers.

The turbine housing 28 defines a circumferential exhaust inlet 32 for receiving the exhaust gas from the engine. The exhaust inlet 32 includes at least one passage for communicating the exhaust gas to the turbine wheel 24. For example, as shown in FIG. 1, the exhaust inlet 32 can be a single passage through which the gas flows. Alternatively, the exhaust inlet 32 can define multiple parallel portions or passages that are separated by a bulkhead so that each passage provides a separate path for the flow of the exhaust gas. For example, each of the passages can receive exhaust gas from a respective source, such as either of two banks of cylinders of the engine, and the passages can deliver the exhaust gas in separate streams to the turbine wheel 24. A dual-path exhaust inlet is further described in U.S. Pat. No. 5,046,317 and U.S. Pat. No. 5,996,348, the entire contents of which are incorporated herein by reference.

A wastegate valve 38 is configured control the flow of the exhaust gas to the turbine 24 by rerouting a portion of the exhaust gas such that it bypasses the turbine 24 via bypass ports 34, 36 to a bypass passage 40, as schematically illustrated in FIG. 1. The bypass ports 34, 36 can communicate with a single portion of the exhaust inlet 32 or, in other embodiments, each bypass port 34, 36 can communicate with a different portion or passage of the exhaust inlet 32. For example, if the exhaust inlet defines multiple passages that provide separate flows of the exhaust gas to the turbine wheel 24, each of the bypass ports 34, 36 can communicate with a distinct portion of the exhaust inlet 32. In either case, the exhaust gas from the exhaust inlet 32 can be discharged through the bypass ports 34, 36 and into the bypass passage 40, which typically discharges the gas to the remaining portions of the exhaust system downstream the turbocharger 10 (e.g. catalytic converter, muffler etc.). Thus, the wastegate valve 38 can be used to discharge or vent gas from the exhaust inlet 32 to prevent some or all of the gas from flowing to the turbine wheel 24, e.g., to limit the operating pressure of the compressor 12 and/or the turbine 22. In an alternative, less preferable embodiment the wastegate valve can be placed upstream the turbine housing thus enabling the vented/discharged exhaust to bypass the turbine inlet 32 entirely.

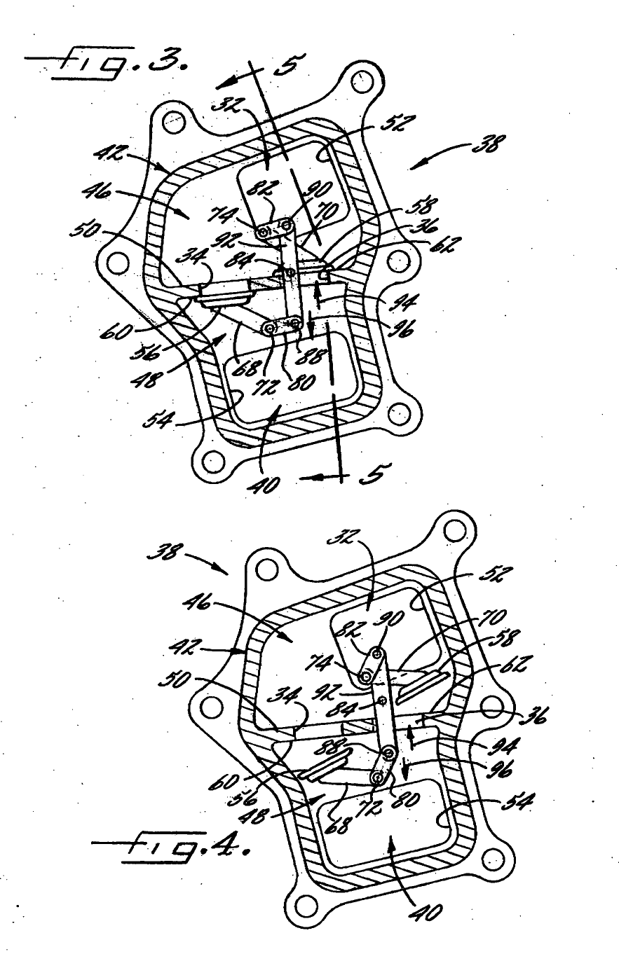

The wastegate valve 38, which is more fully illustrated in FIGS. 2-5, is an assembly that controls the flow of gas from the exhaust inlet 32. A wastegate valve housing 42 defines first and second portions 46, 48, which are separated by a bulkhead 50. The first portion 46 defines an inlet port 52 that is fluidly connected to the exhaust inlet 32, and the second portion 48 defines an outlet port 54 that is fluidly connected to the bypass passage 40. The bulkhead 50 defines the first and second bypass ports 34, 36, which can be opened or closed by respective poppets 56, 58, i.e., valve members that are configured to adjust between open and closed positions. Thus, the gas flows from the exhaust inlet 32 of the turbine 22 into the first portion 46 of the housing 42, and the flow of gas through each of the bypass ports 34, 36 and into the bypass passage 40 is controlled by the poppets 56, 58. In the closed position, each poppet 56, 58 engages and seals a seat 60, 62 surrounding the respective port 34, 36. To adjust to the open position, each poppet 56, 58 is “lifted,” i.e., moved away from the seat 60, 62 so that the port 34, 36 is open to communicate from the exhaust inlet 32 to the bypass passage 40.

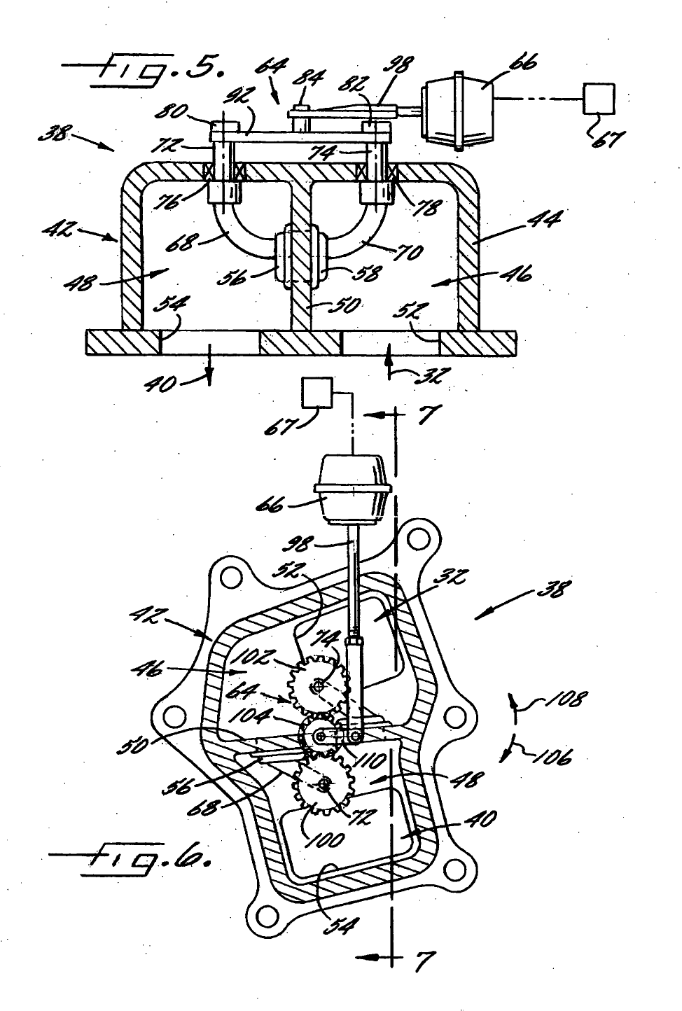

For purposes of illustrative clarity, the wastegate valve 38 is shown in FIGS. 3 and 4 with a cover 44 of the housing 42 removed. As illustrated, the first poppet 56 is configured to move in a downstream direction, i.e., generally away from the exhaust inlet 32, when adjusted from the closed position (FIG. 3) to the open position (FIG. 4); the second poppet 58 is configured to move in an upstream direction, i.e., generally toward the exhaust inlet 32, when adjusted from the closed position (FIG. 3) to the open position (FIG. 4). In other embodiments, the poppets 56, 58 can move in other directions.

The operation of the poppets 56, 58 is controlled by an actuator 66 via a linkage 64. The actuator 66 (omitted in FIGS. 3 and 4 for illustrative clarity) is typically controllably operated by a control device such as an electronic controller 67 that is configured to provide a control signal to the actuator 66, such as for opening, closing, and/or maintaining a position of the wastegate valve 38. Each of the poppets 56, 58 is connected to the linkage 64 so that the poppets 56, 58 are adjusted in unison by the actuator 66. That is, the linkage 64 is configured to selectively adjust in a first direction to open both of the poppets 56, 58 and in a second direction to close both of the poppets. Further, the poppets 56, 58 are adapted to be alternately biased by the gas in the exhaust inlet 32. That is, the first poppet 56 is configured to be biased by the pressure and flow of gas in the exhaust inlet 32 to the open position, and the second poppet 58 is configured to be biased by the pressure and flow of gas in the exhaust inlet 32 to the closed position. Thus, the pressure of the gas in the exhaust inlet 32 provides a force on the first poppet 56 to bias the linkage 64 in one direction and a force on the second poppet 58 to bias the linkage 64 in the opposite direction. The forces on the linkage 64 that result from the pressure of the exhaust gas in the exhaust inlet 32 can be substantially equal so that the linkage 64 is not substantially biased in either direction by the pressure of the exhaust gas. Thus, the linkage 64, and hence the poppets 56, 58, can be adjusted with a reduced force from the actuator 66.

Various configurations of linkages can be used to adjust the poppets 56, 58 between the open and closed positions. As illustrated in FIGS. 2-5, the linkage 64 is a 4-bar mechanism. Each of the poppets 56, 58 is rotatably mounted relative to the bypass ports 34, 36. In particular, as shown in FIG. 5, each poppet 56, 58 is rigidly connected by an arm 68, 70 to a rotatable shaft 72, 74 that extends through the housing 42, and a bearing or bushing 76, 78 can be provided for mounting the shafts 72, 74 relative to the housing 42 so that the housing 42 acts as the “ground” or “frame” member of the 4-bar mechanism. Thus, as the shafts 72, 74 are rotated in alternate directions, the poppets 56, 58 are adjusted between the open and closed positions. The shafts 72, 74 are rotated by relatively adjustable members of the 4-bar mechanism, which are disposed outside the housing 42 in the illustrated embodiment. More particularly, as illustrated in FIGS. 3 and 4, a first crank 80 is connected to the first poppet 56 via the shaft 72 and arm 68, such that the first poppet 56 is configured to rotate with the first crank 80. Similarly, a second crank 82 is connected to the second poppet 58 via the shaft 74 and arm 70, such that the second poppet 58 is configured to rotate with the second crank 82. The end of each crank 80, 82 that is distal to the connection with the respective shaft 72, 74 is connected by a pin connection 88, 90, i.e., a rotatable or hinge connection, to a link member 92. Thus, the linkage 64 constrains the poppets 56, 58 to rotate in unison. That is, as the link member 92 is selectively adjusted in first or second directions, i.e., in the directions indicated by arrows 94, 96, both of the poppets 56, 58 open (FIG. 4) or close (FIG. 3), respectively.

As shown in FIG. 2, the actuator 66 is connected to the link member 92, e.g., by a control rod 98 or other control member that extends from the actuator 66 and is connected by a pin 84 to the link member 92. Alternatively, the actuator 66 can be connected to the linkage 64 by other mechanisms, or the actuator 66 can be connected directly to one of the members of the linkage 64. The actuator 66 can be an electrical device such as a solenoid, a pneumatic device such as a vacuum canister, or various other actuator devices that are configured to push and/or pull. For example, in the embodiment illustrated in FIG. 2, the actuator 66 can be a vacuum device that is configured to pull the control rod 98, and hence the link member 92, in the first direction 94 to thereby open the poppets 56, 58. Similarly, the actuator 66 can be configured to adjust the link member 92 in the second direction 96 to close the poppets 56, 58. In some cases, the actuator 66 can be internally biased to either position, so that a normally open or closed position can be maintained without energizing or otherwise actuating the actuator 66.

Referring to FIGS. 3 and 4, it is seen that the poppets 56, 58 can be equal, or about equal, in size so that each poppet 56, 58 is subjected to about the same force by the pressure of the gas in the exhaust inlet 32. However, even if the poppets 56, 58 are equal in size, the effective area of the poppets 56, 58, i.e., the surface area that is exposed to the pressure of the gas in the exhaust inlet 32, can be different. For example, as shown in FIG. 3, with the poppets 56, 58 closed, the second poppet 58 is subjected to a force proportional to the area of the second poppet 58, while the first poppet 56 is subjected to a force equal to the area of the first bypass port 34, which is slightly smaller than the first poppet 56. If a balance of forces is desired, the first bypass port 34 can be made slightly larger than the second bypass port 36, i.e., about the same size as the second poppet 58. Alternatively, a slight imbalance in pressure on the two poppets 56, 58 can be provided so that the poppets 56, 58 and the linkage 64 are biased slightly to one position and, in the absence of an actuation force by the actuator 66, the linkage 64 is normally maintained in the biased position. Such a bias can be provided in addition or alternative to an internal bias of the actuator 66 or a bias provided by a spring or other member acting on the linkage 64. Nevertheless, it is appreciated that the gas forces on the two poppets 56, 58 can be about equal so that the force required from the actuator 66 for adjusting the position of the poppets 56, 58 is reduced or minimized.

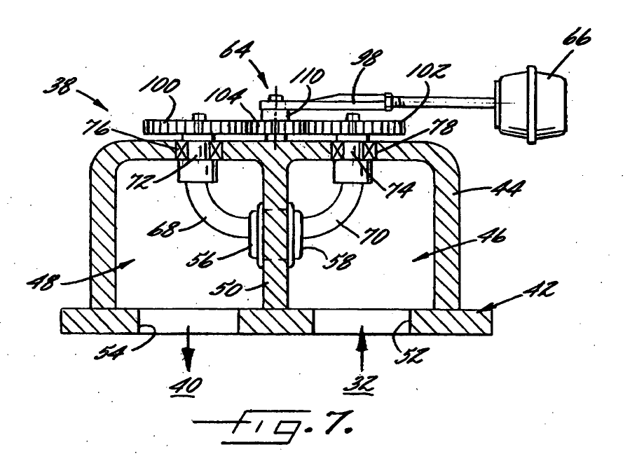

The linkage 64 described above is exemplary, and it is appreciated that various other configurations can be provided instead. For example, FIGS. 6 and 7 illustrate another embodiment of the present invention in which the linkage 64 of the wastegate valve 38 includes gears 100, 102, 104 for coordinating or constraining the adjustment of the two poppets 56, 58. As shown in FIG. 7, the poppets 56, 58 are connected by the arms 68, 70 to the shafts 72, 74 and rotatable about axes extending through the cover 44 of the housing 42. The first and second shafts 72, 74 are connected to the first and second gears 100, 102, respectively, so that the shafts 72, 74 and poppets 56, 58 are configured to be adjusted by rotation of the gears 100, 102. As shown in FIG. 6, the third gear 104 is disposed between, and engaged with, the first and second gears 100, 102. Thus, the third gear 104 operates as a link member to constrain the first and second gears 100, 102 to rotate in unison. That is, as the third gear 104 is adjusted in a first direction, i.e., in the direction indicated by arrow 106, the first and second gears 100, 102 are adjusted (counterclockwise, as shown in FIG. 6) so that the poppets 56, 58 open. Alternatively, as the third gear 104 is adjusted in a second direction, i.e., in the direction indicated by arrow 108, the first and second gears 100, 102 are adjusted (clockwise, as shown in FIG. 6) so that the poppets 56, 58 close.

In the illustrated embodiment, the control rod 98 is connected to the third gear 104 by a lever 110, and the actuator 66 is configured to push the rod 98 to open the poppets 56, 58 and pull the rod 98 to close the poppets 56, 58. Alternatively, the actuator 66 can be otherwise connected to the linkage, e.g., by a direct connection from one of the gears to a rotational actuator configured to rotate the gear. As described above, the actuator 66, the linkage 64, or the poppets 56, 58 can be balanced equally in both directions or can be biased to either the open or closed position so that the poppets 56, 58 tend to move to the biased position, e.g., if no control signal is provided to control the actuator 66. In either case, the forces provided on the poppets 56, 58 by the pressure of the gas in the exhaust inlet 32 act in opposite directions on the linkage 64 so that the forces are offset, partially or completely. Thus, a reduced force is required from the actuator 66 for selectively adjusting the poppets 56, 58 to the desired position.

According to one method of the present invention, the flow of gas from the exhaust inlet 32 is controlled by selectively adjusting the position of the poppets 56, 58 between the open and closed positions. For example, the controller 67 can control the actuator 66 according to measured inputs such as the pressure in the turbine 22 or compressor 12, the desired output from the compressor 12, and the like. Upon determining that the wastegate valve 38 should be adjusted open or closed, the controller 67 can issue a signal to the actuator 66 to adjust the linkage 64 and, hence, the poppets 56, 58. Thus, the actuator 66 pulls, pushes, rotates, or otherwise actuates the linkage 64 as appropriate for making the desired adjustment, and the poppets 56, 58 are adjusted with the linkage 64, e.g., by rotation about the axes defined by the shafts 72, 74 so that the poppets 56, 58 rotate toward or away from the respective bypass ports 34, 36.

Each of the poppets 56, 58 is also subjected to a force determined by the difference in pressure between the exhaust inlet 32 and the bypass passage 40 and the effective area of each poppet 56, 58; however, the forces tend to oppose one another. That is, the force of the gas acting on the first poppet 56 tends to open or close the poppet 56 and thereby biases the linkage 64 in one direction. For the same pressure condition in the exhaust inlet 32 and the bypass passage 40, the force of the gas acting on the second poppet 58 tends to adjust the second poppet 58 oppositely, thereby biasing the linkage 64 in the opposite direction. Thus, the forces due to the gases offset one another either partially or entirely, so that a reduced force is required from the actuator 66 for adjusting the linkage 64.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific and/or preferred embodiments disclosed and that modifications and other embodiments are intended to be included within the scope of the appended claims. Although specific terms are employed herein, they are used in a generic and descriptive sense only and not for purposes of limitation.

What is claimed is:

1. A wastegate valve for controlling a flow of gas from an exhaust inlet of a turbocharger, the wastegate valve comprising:
first and second bypass ports communicating with the exhaust inlet;
a first poppet configured to adjust between open and closed positions, the first poppet in the closed position engaging and sealing a seat surrounding the first bypass port, and the first poppet being biased by the gas in the exhaust inlet to the open position;
a second poppet configured to adjust between open and closed positions, the second poppet in the closed position engaging and sealing a seat surrounding the second bypass port, and the second poppet being biased by the gas in the exhaust inlet to the closed position; and
a linkage connecting the first and second poppets and configured to adjust in a first direction to open the first and second poppets and adjust in a second direction to close the first and second poppets, such that a gas in the exhaust inlet provides a force on the first poppet to thereby bias the linkage in the first direction and a force on the second poppet to thereby bias the linkage in the second direction.

2. A wastegate valve according to claim 1 wherein the first poppet is rotatably mounted to rotate about a first axis between the open and closed positions and the second poppet is rotatably mounted to rotate about a second axis between the open and closed positions, and the linkage constrains the poppets to rotate in unison.

3. A wastegate valve according to claim 2 wherein the linkage comprises:
a first crank connected to the first poppet and configured to rotate the first poppet about a first axis between the open and closed positions;
a second crank connected to the second poppet and configured to rotate the second poppet about a second axis between the open and closed positions; and
a link member rotatably connected to the first and second cranks such that the link member constrains the cranks to rotate in unison and thereby constrains the poppets to adjust in unison.

4. A wastegate valve according to claim 2 wherein the linkage comprises:
a first gear connected to the first poppet and configured to rotate the first poppet about a first axis between the open and closed positions;
a second gear connected to the second poppet and configured to rotate the second poppet about a second axis between the open and closed positions; and
a third gear rotatably mounted to engage each of the first and second gears such that the third gear constrains the first and second gears to rotate in unison and thereby constrains the poppets to adjust in unison.

5. A wastegate valve according to claim 1 wherein the gas in the exhaust inlet provides a substantially equal force on the linkage in the first and second directions.

6. A wastegate valve according to claim 1 wherein an effective area of the first poppet in communication with the exhaust inlet is about equal to the effective area of the second poppet in communication with the exhaust inlet.

7. A wastegate valve according to claim 1, further comprising an actuator in communication with the linkage and configured to selectively adjust the poppets between the open and closed positions.

8. A wastegate valve according to claim 1 wherein the first poppet is configured to adjust from the closed position to the open position in an upstream direction generally toward the exhaust inlet, and the second poppet is configured to adjust from the closed position to the open position in a downstream direction generally away the exhaust inlet.

9. A wastegate valve for controlling a flow of gas from an exhaust inlet of a turbocharger, the wastegate valve comprising:
at least one bypass port communicating with the exhaust inlet;
first and second adjustable members configured to adjust between open and closed positions, the adjustable members in the closed position substantially closing each bypass port and each bypass port being open with the adjustable members in the open position, each of the adjustable members being biased to opposite open and closed positions by a pressure of the gas in the exhaust inlet;
a linkage connecting the first and second adjustable members and configured to adjust in a first direction to open the first and second adjustable members and adjust in a second direction to close the first and second adjustable members, such that a gas in the exhaust inlet provides a force on the first adjustable member to thereby bias the linkage in the first direction and a force on the second adjustable member to thereby bias the linkage in the second direction.

10. A wastegate valve according to claim 1 wherein the gas in the exhaust inlet provides a substantially equal force on the linkage in the first and second directions.

11. A method for controlling a flow of gas from an exhaust inlet of a turbocharger, the method comprising:
providing a first poppet adjustable between open and closed positions for opening and closing a first bypass port in communication with the exhaust inlet;
providing a second poppet adjustable between open and closed positions for opening and closing a second bypass port in communication with the exhaust inlet; and
selectively adjusting a linkage connected to the first and second poppets in a first direction to open the first and second poppets and in a second direction to close the first and second poppets, a pressure on the first poppet provided by the gas in the exhaust inlet and biasing the linkage in the first direction being opposed by a pressure on the second poppet provided by the gas in the exhaust inlet and biasing the linkage in the second direction.

12. A method according to claim 11 wherein the gas in the exhaust inlet provides substantially equal forces on the first and second poppets, and said adjusting step comprises providing an additional force on the linkage.

13. A method according to claim 11 wherein said adjusting step comprises rotating the first and second poppets in unison between the open and closed positions, the first poppet rotating about a first axis and the second poppet rotating about a second axis.

14. A method according to claim 13 wherein said adjusting step comprises adjusting a link member in alternate first and second directions, adjustment of the link member in the first direction thereby rotating first and second cranks in unison, the first crank being connected to the first poppet such that the first poppet rotates about a first axis between the open and closed positions and the second crank being connected to the second poppet such that the second poppet rotates about a second axis between the open and closed positions.

15. A method according to claim 13 wherein said adjusting step comprises adjusting first, second, and third gears, the first gear being connected to the first poppet and configured to rotate the poppet about a first axis between the open and closed positions, the second gear connected to the second poppet and configured to rotate the poppet about a second axis between the open and closed positions, and the third gear rotatably mounted to engage each of the first and second gears such that the third gear constrains the first and second gears to rotate in unison and thereby constrains the poppets to adjust in unison.

16. A method according to claim 11 wherein said providing steps comprise providing the first poppet with an effective area in communication with the exhaust inlet and the second poppet with an effective area in communication with the exhaust inlet, the effective areas of the poppets being about equal.

17. A method according to claim 11 wherein said adjusting step comprises energizing an actuator in communication with the linkage and thereby adjusting the poppets between the open and closed positions.

18. A method according to claim 11 wherein said adjusting step comprises adjusting the first poppet from the closed position to the open position in an upstream direction generally toward the exhaust inlet, and adjusting the second poppet from the closed position to the open position in a downstream direction generally away the exhaust inlet.
